(19) United States
(12) Patent Application Publication
(10) Pub. No.: US 2003/0061100 A1
(43) Pub. Date: Mar. 27, 2003

(54) POS system, network system, advertisement information delivering method and recording medium recording the method

(76) Inventor: Masahiro Minowa, Nagano (JP)

Correspondence Address: NIXON & VANDERHYE P.C., 8th Floor, 1100 North Glebe Road, Arlington, VA, 22201, US

(21) Appl. No.: 10/256,267

(22) Filed: Sep. 27, 2002

(30) Foreign Application Priority Data
Sep. 27, 2001 (JP) P2001-297760

(51) Int. Cl. G06F 17/60

(52) U.S. Cl. 705/14

(57) ABSTRACT

An advertisement delivering method and system that accepts an application for advertisement information and determines an inherent code to the advertisement information and converts the same code into a machine readable code such as a bar code to be added to a print medium. The advertisement information is delivered to a store through a network and is read through the bar code in a store using the print medium. Consequently, advertisement information corresponding to the bar code is determined, and is printed and output to the receipt of the store.

### BACKGROUND OF THE INVENTION

1. Field of the Invention

The present invention relates to an advertisement delivering system and method for printing various information (hereinafter referred to as advertisement information).

2. Description of the Related Art

There have been proposed a POS (Point of Sales) system for printing receipt information by utilizing a receipt paper having advertisement information printed previously on a surface or a back face to thereby provide the advertisement information which is to be used in a convenience store or the like. In addition, also proposed has been a POS system capable of printing, as additional information on a receipt, information such as an advertisement input from an information input terminal provided in a store. In the former example, a fixed advertisement can be provided for a long period of time. In the latter example, local event information or advertisements can be directly provided to individual local residents. Because of diverse personal lifestyles and geographical differences, such a system will become a very effective advertisement medium in the near future.

In the former example of the related art, however, printed paper is used. Therefore, the fixed information can be provided for a long period of time. In detriment, however, a time lag is generated with a change in the advertisement information. Therefore, various advertisements cannot be inserted timely. In the latter example, moreover, in the case in which an advertisement insertion is desired, it is necessary to go to a store provided with an information input terminal and to take an application procedure for the advertisement insertion by using an information input terminal in order to make the application. For this reason, the application procedure is cumbersome.

### SUMMARY OF THE INVENTION

In consideration of such inefficiencies in the related art, the present invention has an object to provide an advertisement delivering system in which advertisement information is printed by means of a POS terminal device in a branch (including a store) of a chain store desired by an advertiser or a subscriber store to an advertisement information delivery service provider through a network, such as the internet, and a method of accepting an insertion application to insert an advertisement.

Moreover, the invention has an object to provide an advertisement delivery system capable of causing an advertiser to pay advertisement charges without any anxiety.

In this specification, the term branch is used to conceptually include branches of various organizations such as a bank or a stock company, a store to be a branch of a supermarket or a department store, and an affiliated store which is under a predetermined contract to a convenience store. Moreover, the POS terminal device is used as a POS terminal device on the POS concept in a wide sense which is referred to as a so-called point of service which includes a device for issuing a ticket or an acceptance number ticket, an automatic teller machine (ATM) for issuing a detailed statement, and a device for issuing various printed matters in addition to a POS register connected to a POS system to be used in a store.

In order to achieve the objects, the invention provides the following means. In a network system according to a first aspect of the invention, a POS system comprising a POS terminal device having a printing device for printing POS information and a display device, comprises a storage device for storing predetermined codes and associated advertisement information, a print medium or a container thereof which is used in the printing device and has one of the codes added to at least one of a body and a wrapper of the print medium or container, a code reader for reading the code added to the print medium or the container thereof, and a print controller for controlling printing of the advertisement information together with the POS information, wherein the advertisement information associated with the code is printed together with the POS information while the print medium or the container thereof is attached.

Moreover, the invention provides a network system comprising a server system and a POS system including a POS terminal having a printing device for printing POS information and a display device, comprising: (a) an advertisement data delivery network for delivering advertisement data including predetermined codes and associated advertisement information from the server system to the POS system, (b) a print medium or a container thereof which is used in the printing device and has one of the predetermined codes added to at least one of a body and a wrapper of the print medium or container, (c) a code reader for reading the code added to the print medium or the container thereof, (d) a data storage and management device for retaining and manipulating the delivered advertisement data in the POS system, and for comparing the code read by the code reader with the predetermined codes, thereby determining associated advertisement information, and (e) a print controller for controlling printing of the specified advertisement information together with the POS information.

According to this aspect, an advertiser provides the print medium, for example, an ink cartridge to a store. In the store, a code added to a body of the print medium, for example, a bar code is read. Consequently, the advertisement of the provider of the attached print medium can be printed on the receipt of the store based on the correspondence relationship between the advertisement information delivered through a network and the code. Thus, the advertisement information is delivered timely from the POS system through, for example, the internet. Therefore, the advertiser can carry out advertising which is not fixed information but is required at that time or is effective.

Furthermore, the invention provides the network system, further comprising a center computer for unifying and controlling a plurality of store POS systems provided corresponding to each chain store having a plurality of branches or subscriber stores.

According to this aspect, it is sufficient that a server to deliver an advertisement transmits advertisement data to the center computer of a chain store. Consequently, it is possible to quickly deliver the advertisement information from the center computer to each store POS system or a POS terminal device in the system.

The invention provides the POS system, wherein the POS terminal device includes a print medium detector for detecting attachment and removal of the print medium or the container thereof, the print controller operable to stop the printing of the advertisement information when the print medium detector detects that the print medium or the container thereof is removed, and wherein the POS terminal device includes a display controller for controlling the display of an instruction for reading the code of the print medium or the container thereof on the display device when the print medium detector detects that the print medium or the container thereof is removed or attached.

Furthermore, the POS terminal device includes a code controller for transferring the code to an upper device when an operation for reading the code of the print medium or the container thereof is executed after attachment of the print medium or the container thereof is detected.

According to this aspect, the code added to the print medium, for example, a thermal recording paper can be updated when the recording paper is to be exchanged. Consequently, it is possible to accurately print an advertisement specified by the code.

The POS system according to the invention is characterized in that the code added to the print medium or the container thereof may be a bar code.

According to this aspect, a bar code reader which is usually provided in the POS terminal device can be used for reading a code determining the advertisement information.

The invention is further characterized in that the code added to the print medium or the container thereof is a code for determining an advertiser and advertisement information.

According to this aspect, the POS terminal device reading a code can display an advertiser specified by the code on a customer display, thereby enhancing the advertising effect to a store customer.

Further still, the invention is characterized in that the code to be used is a bar code which is added to at least one of a tip portion of a rolled paper of the thermal recording paper and a wrapping paper for wrapping the rolled paper.

According to this aspect, it is possible to read a bar code determining advertisement information from the wrapping paper after the rolled paper is attached.

The invention provides an advertisement information delivering method in a network system comprising, as components, at least a server system and a POS system including a store POS terminal device having a display device and a print device, comprising the steps of (a) delivering advertisement information to be printed on a receipt in a store POS terminal device corresponding to a predetermined code from the server system to the POS system through a network, (b) reading a code added to a print medium attached to the printing device or a container accommodating the print medium in the store POS terminal device of the POS system, (c) determining the advertisement information from the code added to the print medium or the container accommodating the print medium which is read, and (d) printing the advertisement information corresponding to the code added to the print medium or the container accommodating the print medium which is specified on the receipt of the store POS terminal device together with receipt information of the POS terminal device. Furthermore, the advertisement information delivering method comprises the steps of (e) detecting attachment and removal of the print medium or the container accommodating the print medium, and (f) stopping the printing of the advertisement information corresponding to the print medium or the container accommodating the print medium when the removal of the print medium or the container accommodating the print medium is detected.

According to this aspect, the print medium is set to the POS system. Consequently, the advertisement information specified by the code added to the print medium can be printed as additional information on a printing matter such as a receipt, and furthermore, the advertisement can be delivered timely.

The invention provides the advertisement information delivering method, further comprising the step of reading a code added to the print medium or the container accommodating the print medium and then transferring the code to an upper device.

According to this aspect, the upper device can fetch the advertisement information corresponding to the code from the stored data and can transfer the same advertisement information to the POS terminal device, thereby executing the preparation of print.

### BRIEF DESCRIPTION OF THE DRAWINGS

FIG. 1 is a view for explaining the configuration of a business in which a network system according to the invention is used;

FIG. 2 is a schematic view showing an embodiment of a print medium to be used in the invention;

FIG. 3 is a diagram showing an embodiment of a network system to be used in the invention;

FIG. 4 is a diagram showing an example of the basic structure of an acceptance and delivery server system according to the invention;

FIG. 5 is a diagram showing the structure of a store POS system according to the invention;

FIG. 6 is a view showing the external appearance of a POS terminal device in a convenience store according to an example of a POS terminal device according to the invention;

FIG. 7 is a block diagram showing the structure of an internal circuit of the POS terminal device according to the invention;

FIG. 8 is a diagram showing the structure of the function of a store server according to the invention;

FIG. 9 is a flow chart for explaining a processing of making an application for an advertisement insertion according to the invention;

FIG. 10 is a flow chart for a processing of setting and printing advertisement information according to the invention;

FIG. 11 is a flow chart showing a more detailed processing of exchanging a rolled paper and reading a bar code according to the invention; and

FIG. 12 is a view showing an example of a receipt having advertisement information printed under account processing data.

### DETAILED DESCRIPTION OF PREFERRED EMBODIMENTS

Embodiments of the intention will be described below in detail with reference to the drawings.

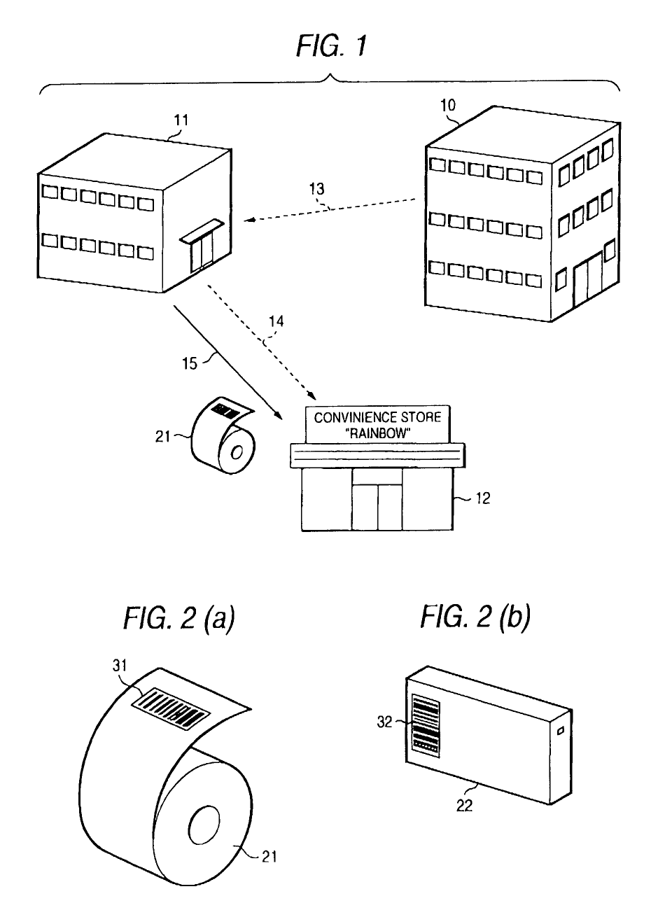

FIG. 1 is a view for explaining a business configuration in which a network system according to the invention is used.

A company which wants to print and output an advertisement on a receipt, that is, an advertiser 10 makes an application with advertisement data to a company such as an advertising agency for giving a service of information delivery, that is, an advertisement delivery company 11. At this time, a chain store for carrying out advertising or the number of recording rolled papers for the receipt on which an advertisement is to be printed is specified. It is convenient that such an application may be made by accessing the internet home page of the advertisement delivery company. An arrow 13 indicates that advertisement information and application information are sent as electronic data. The advertisement delivery company 11 determines a predetermined code for determining the advertisement information of the advertiser 10 and registers the same code in the computer of the advertisement delivery company 11. The predetermined code can also combine an inherent code to the advertiser which is indicative of the advertiser. Moreover, the code can encode and include information about the data of the application and an advertising store.

The advertisement delivery company converts the specific code into a bar code and prints the bar code on a label by using a bar code generation printing device. The labels corresponding to the number of the applications made from at least the advertiser are created. The printing may be directly carried out over a rolled paper or a wrapping paper thereof in place of the label.

Upon receipt of an order of a recording paper for a receipt from a store 12 which is under contract or the head office of a chain store (not shown), the advertisement delivery company 11 sticks the label onto at least one of the tip portion of a rolled paper and a wrapping paper thereof. The rolled papers in such quantity as to correspond to the order given from the store 12 including the rolled paper having the label stuck thereto are packed and delivered. An arrow 15 shown in a solid line indicates a flow from the advertisement delivery company 11 to the store 12.

On the other hand, data for an advertisement which are received from the advertiser 10 are registered in a server system (not shown) for advertisement delivery of the advertisement delivery company 11 corresponding to the predetermined code. Also in this case, the data are transferred to the computer of a predetermined store or a chain store through the internet. An arrow 14 shown in a dotted line indicates a flow of information.

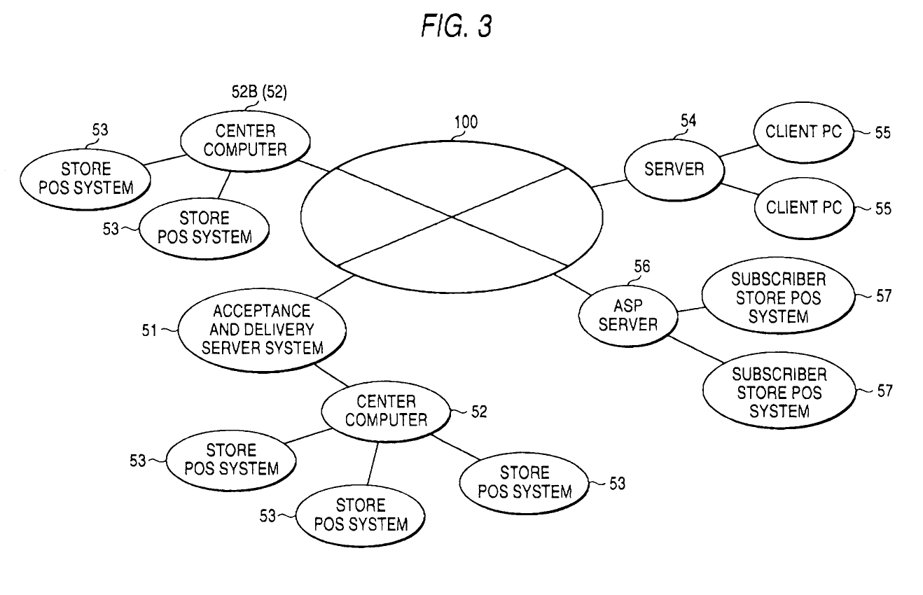

FIG. 2 shows an embodiment of a print medium to be used in the invention which is sent from the advertisement delivery company 11. 21 in FIG. 2(a) denotes a rolled paper to be a thermal recording paper and a bar code label 31 described above is stuck onto a tip portion thereof. In this case, it is preferable that a label having the same bar code printed thereon should also be stuck onto a wrapping paper (not shown) for protecting the thermal paper. 22 in FIG. 2(b) denotes an ink cartridge which is to be attached to an ink jet printer using an ink as a print medium. In the embodiment, the ink cartridge is used as a container for the ink to be the print medium. A bar code label 32 is stuck onto the side surface of the cartridge 22. In general, the ink cartridge is put in a packaging box and is thus sold. For this reason, it is preferable that the label having the same bar code should also be stuck onto the packaging box. p FIG. 3 shows an embodiment of the network system according to the invention. In the drawing, 51 denotes an acceptance and delivery server system for accepting and delivering the application for an advertisement insertion, and 52 denotes a center computer. For example, the center computer 52 indicates a system which is connected to a point of sales system (hereinafter referred to as a POS system) having a POS terminal device in a convenience store, for example, and serves to unitarily manage data collected from the POS terminal device. In some cases, generally, the center computer 52 is wholly referred to as the POS system in addition to an apparatus on the store side. In this specification, the POS system is used to be a system on the branch side separated from the center system as described above.

53 denotes a store POS system provided in each store. The store POS system 53 serves to manage a store register (which will be described below in detail) to be a POS terminal device for issuing a receipt with advertisement information thereon. 54 and 56 denote servers to be connected to the internet 100. 55 denotes a client PC which is a computer of the application side for an advertisement insertion, that is, an advertiser and for which a personal computer (hereinafter referred to as a PC) is generally used. In FIG. 3, the center computer 52 is connected to the acceptance and delivery server system 51 through a private line. On the other hand, it is assumed that a center computer 52B (52) is connected through the internet and is usually managed by a different trader from the acceptance and delivery server system 51. Both of them function as host machines in original chain stores, respectively. In the following description, they are not distinguished from each other but are generally referred to as the center computer 52.

The client PC 55 accesses the acceptance and delivery server system 51 through the server 54 connected to the internet 100. The client PC 55 may be a PC connected to a telephone circuit or a PC connected to a network of an organization such as a company. Moreover, the server 54 to which the client PC 55 is connected may be an internet service provider, that is, a so-called provider or a private server of the client PC 55.

The acceptance and delivery server system 51 transmits an application form at the request of the client PC 55. The client PC 55 returns predetermined application information and advertisement information based on the acquired application form. The acceptance and delivery server system 51 stores the received information and transmits a confirmation mail indicative of the acceptance.

The acceptance and delivery server system 51 confirms the payment of charges and then delivers advertisement information and management information to the store POS system 53 specified by the client PC 55 through the center computer 52. The advertisement and management information include the predetermined code. For example, it is also possible to directly deliver the information to the store POS system 53 without the center computer 52 by utilizing an intra-network system such as a client server system, which is not shown.

The store POS system 53 receiving the advertisement information prints the advertisement information transmitted from the acceptance and delivery server system 51 in addition to original print matters (an adjusted amount of purchased goods) onto a receipt issued by a store. At this time, the store POS system 53 is so constituted as to select and print advertisement information in which a predetermined code specified by the management information is coincident with a code added to a print medium, for example, a thermal recording paper or a container for the print medium, for example, an ink cartridge.

The store POS system 53 includes various systems for issuing a predetermined printed matter to a customer, for example, an acceptance number issue system to be used in a bank and a stock company in addition to a POS system to be used in a convenience store, a department store, a supermarket, a shopping mall, and so forth.

The server 56 is operated by a service trader referred to as an application service provider (ASP) and a subscriber store receives various services such as stock control, financial affairs and tax management through a subscriber store POS system 57. In many cases, such a store is generally small-scaled to have one or two POS terminal devices to be the POS system. In some cases, moreover, the terminal device is directly connected to the server 56 without an original server.

The acceptance and delivery server system 51 can also deliver advertisement related information including the received advertisement information to another subscriber POS system 57 through the internet 100 and the server 56. In this case, such a subscriber store can have any business condition and may be directed to a clinic, a drugstore, and middle and small-scaled stores, for example. In the case of the clinic and the drugstore, a printed matter such as a receipt or an acceptance number ticket may be issued by a register for clearing a doctor's fee and hospital charges, and an acceptance number issue device for issuing a number ticket in order of an acceptance and a register of a drugstore for providing a medicine according to a doctor's prescription. In the invention, the POS terminal device, the register and the acceptance number ticket issue device which are used in the POS system described above and the subscriber store POS system are generally referred to as the POS terminal device.

Acceptance and Delivery Server System

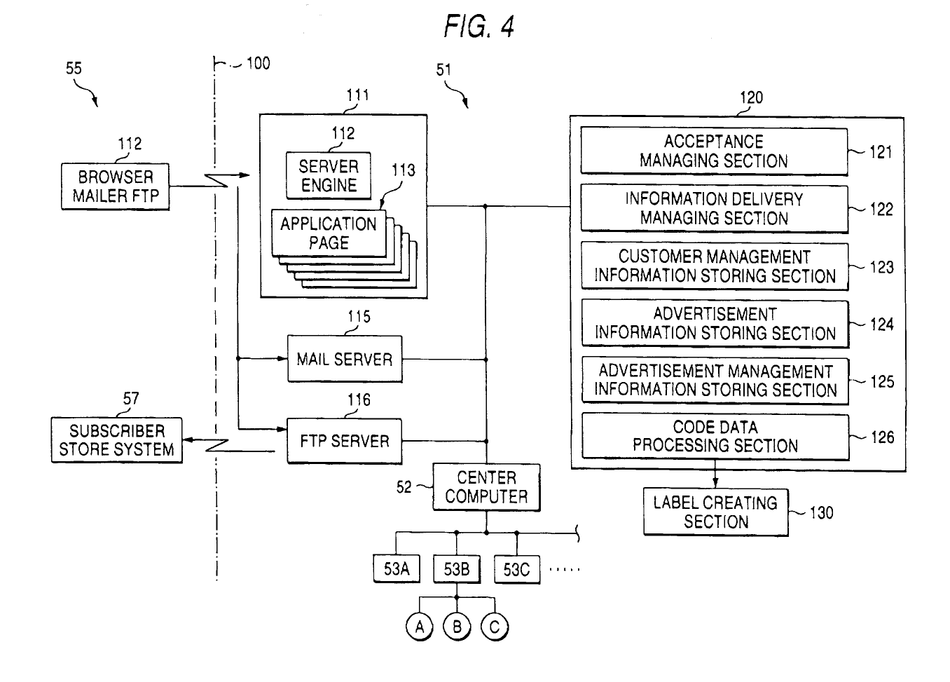

FIG. 4 shows an example of the basic structure of the acceptance and delivery server system 51. A world-wide web (WWW) server 111 is provided with a storage device for storing various data which is not shown, and stores a home page (not shown), other Web pages, and furthermore, information to be provided to the Web pages and transmits the home page and the other Web pages to the client PC 55 at the request of the client PC 55. The client PC 55 can acquire the home page through the browser. For example, it is assumed that the client PC 55 desires the application for an advertisement insertion through the home page. That is, when a predetermined portion on the home page is clicked, an application page transmission request is sent to the acceptance and delivery server system 51 by carrying out setting to send the application page transmission request to the WWW server 111. Upon receipt of the application page request from the client PC 55, a server engine 112 of the WWW server 111 transmits an application page 113 to the client PC 55.

When the advertiser 10 executes a predetermined input of customer management information such as the name of a company, a name or a mail address, and advertisement management information such as a region and the name of a store in which an advertisement is to be inserted in accordance with the application page 113, and further inputs advertisement information about the contents to be inserted, the client PC 55 transmits this advertisement related information to the acceptance and delivery server system 51. Upon receipt of the data transmitted from the client PC 55, the WWW server 111 of the acceptance and delivery server system 51 transmits the same data to another server such as an acceptance and delivery management server 120. The acceptance and delivery management server 120 carries out a predetermined processing as necessary.

As the advertisement information sent from the client PC 55, image data such as a picture or a photograph can also be accepted in addition to character data. Any method may be used for a method of receiving the image data. For example, it is also possible to transfer the image data as an attachment file of a mail from the client PC 55 and to receive the same image data by a mail server 115. Furthermore, the application page 113 may be caused to include an ID and a password of an FTP server 116 and an image file may be automatically transferred to the FTP server 116 by the operation of the application page 113 through an FTP (file transfer protocol).

The data input in accordance with the procedure of the application page 113 are subjected to a predetermined processing by an acceptance managing section 121 of the acceptance and delivery management server 120. The client management information and the advertisement management information to be the application related information are stored in a customer management information storing section 123 and an advertisement management information storing section 125 respectively, and the advertisement information is stored in an advertisement information storing section 124. In these storing sections 123 to 125, the information is related as electronic data and is registered and stored in an appropriate database. The information stored in the storing sections and registered formally is managed by an information delivery managing section 122, and the information is delivered by a predetermined processing.

The acceptance managing section 121 makes a credit inquiry based on the ID, password or credit number of the advertiser 10, and considers an application to be decided and formally registers the memory of each of the storing sections 123 to 125 if an identity can be proved reliably. Next, the information delivery managing section 122 of the acceptance and delivery management server 120 transfers advertisement information and a code for designating at least the advertisement information corresponding to each other to the center computer 52 connected to a plurality of predetermined store POS systems in accordance with management information. The center computer 52 may transfer the data to a POS system in a region specified by the client PC 55 or the store POS system 53 of a store specified directly. In addition, it is possible to specify the delivery to only, for example, A and B stores in store POS systems 53A to 53C. Moreover, it is also possible to use a method of once storing data in the center computer 52 and to deliver the same data at the request of the store POS system. While FIG. 4 shows a configuration in which a hierarchical connection to the center computer 52 is provided, the connection may be carried out in the form of a client server system.

In the case in which the subscriber store POS system 57 to be an external advertisement insertion service is not connected to the acceptance and delivery server system 51 through an internal network, data required for an advertisement are transferred through the internet 100.

If a change in the advertisement contents is set in the management information, for example, in addition to the information delivery processing, the information delivery managing section 122 gives an instruction for stopping the current advertisement insertion and carrying out an update to new advertisement contents in accordance with the management information. Moreover, if an obligation to report the number of issued sheets is set, the information delivery managing section 122 receives information about a print output number at which an actual issuance is periodically carried out from the center computer 52 or the subscriber store POS system 57 and adds the information to calculate the total number of issued sheets and to retain the same number as data to answer the inquiry from the advertiser 10.

A code data processing section 126 determines a code for designating data on advertisement information transmitted simultaneously according to an application from the advertiser 10, converts the code into a bar code and transfers the bar code to a label creating section 130. The label creating section 130 prints a predetermined bar code according to the bar code data thus transmitted, and creates a predetermined number of labels.

In the case in which the information delivery is restricted to only the POS system connected to the center computer 52, moreover, such management can also be moved to the center computer 52.

POS System and Store Register

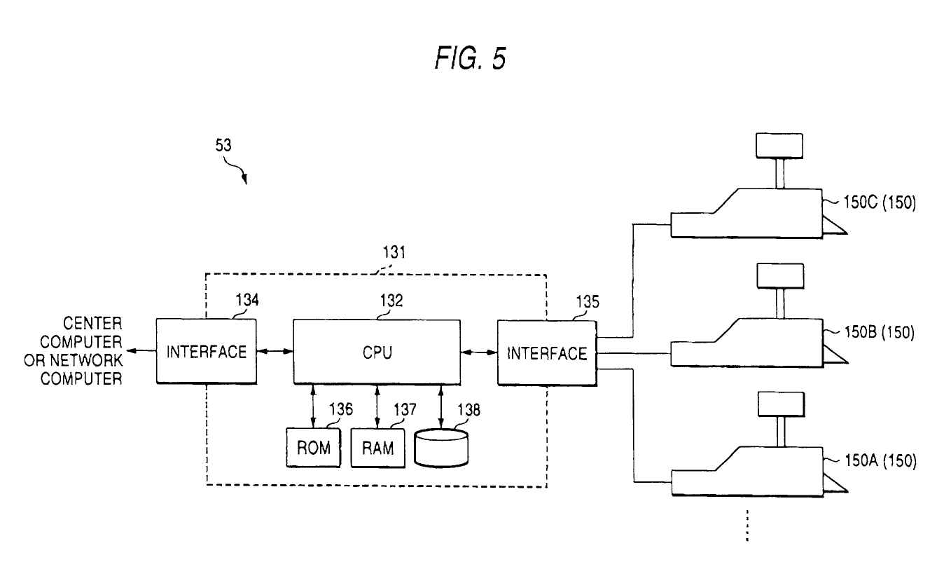

FIG. 5 shows an example of the structure of the store POS system 53. The store POS system 53 is provided with a store server 131 to be the upper device of the POS terminal device, and a plurality of POS terminal devices 150a to 150c (hereinafter referred to as a POS terminal device 150) are connected to the store server 131 of the store POS system 53. The store server 131 does not need to be always provided for each store but may be provided for each fixed region.

Each portion of the store server 131 is controlled by a CPU 132. The CPU 132 constitutes a control section including an ROM 136, an RAM 137 and a hard disk driver (HDD) 138 as main components.

The store server 131 communicates with the center computer 52 through an interface 134. On the other hand, the store server 131 also communicates with the POS terminal device 150 through an interface 135 on the POS terminal device side. The store server 131 receives, through the interface 134, advertisement information transmitted from the center computer 52 and advertisement management information including a predetermined code, and stores them in a storage device such as a hard disk drive 138. The storage device stores a product code and a price for a product sold at the store. The CPU 132 receives, through the interface 135 on the POS terminal device side, the identification number of a product which is transmitted from the POS terminal device 150, and transfers data on the price of the product to the POS terminal device 150 through the interface 135.

The store server 131 can transmit a product sales situation to the center computer 52 through the interface 134 and can obtain various information such as update information about a purchase plan and a product price from the center computer 52. Furthermore, it is also possible to directly communicate with the acceptance and delivery server system 51 in a connection with a computer communication network using a digital communication line through a network interface which is not shown. The store server 131 functions as a section for storing various data, and furthermore, functions as print control means for receipt information or advertisement information in cooperation with the POS terminal device 150.

While the structure of the store POS system 53 has been described in this example, the subscriber store POS system 57 is connected to the internet 100 through the interface 134 and the ASP server 56 such as a provider (see FIG. 2).

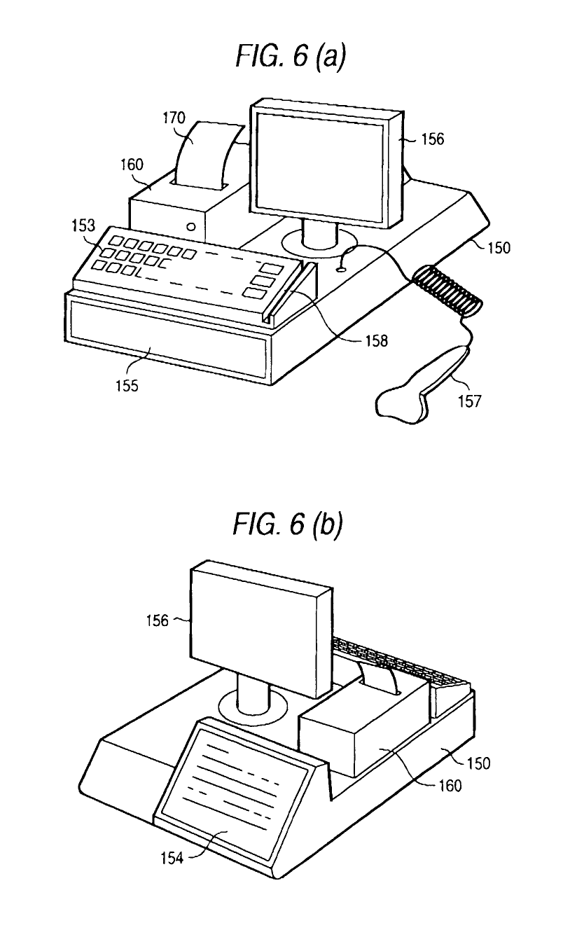

FIG. 6 is a schematic view showing the external appearance of the POS terminal device 150 of a convenience store as an example of the POS terminal device according to the invention. The POS terminal device 150 has a keyboard 153 for an operator, a customer display 154, a cash drawer 155, a display 156 for an operator, a receipt printer 160 and a bar code scanner 157. As an example, a thermal printer is used for the receipt printer 160 and a thermal recording paper 170 is used for a print medium.

In FIG. 6, the bar code scanner 157 functions as code reading means to be used for reading a bar code added to a product and executing a money register processing. In the invention, furthermore, the bar code scanner 157 is also utilized for reading a bar code added to a thermal recording paper to be used in the receipt printer 160.

If a clearing request is given from a customer in a convenience store, customer information such as, for example, their age, sex, zip code, etc. is first input. These data may be collected and analyzed as business strategy information such as a sales analysis in the center computer 52 for managing the whole store POS system of a chain store. After the customer information is input, a purchased product is registered. When all the products are completely registered, the receipt 170 having a purchase item, a total amount of money and a consumption tax printed thereon is issued from the printer 160 and is given to the customer.

The product register implies a series of processings of reading a bar code added to a product to read the price of the product from the storage device 138 of the store server 131, storing the name, price and number of the purchased products in the storage device of the POS terminal device 150, and subtracting the number of the purchased products from stock data.

The POS terminal device 150 to be used in the invention further serves to print advertisement information on the receipt 170 and to hand the advertisement insertion receipt to a customer, thereby fulfilling the advertising functions. As shown in FIG. 2, the bar code added to the tip portion of the rolled paper of the thermal recording paper 21 or the wrapping paper thereof is read by an operator's manipulation using the bar code reader 157 when the rolled paper is newly set. Based on code data of the bar code, advertisement information corresponding to the set rolled paper is selected from the data retained in the storage device 138 and is prepared to be conveniently printed as the advertisement information on the receipt. In this case, if the data are transferred from the store server for each receipt printing, a processing time is increased. Therefore, it is preferable that the data should be previously downloaded into the storage device in the POS terminal device 150.

The customer display 154 in FIG. 6 may exactly display the advertisement information to be printed which is specified by the advertiser 10 or may display different related information from the information to be printed on the receipt, for example, the introduction of the company of the advertiser 10.

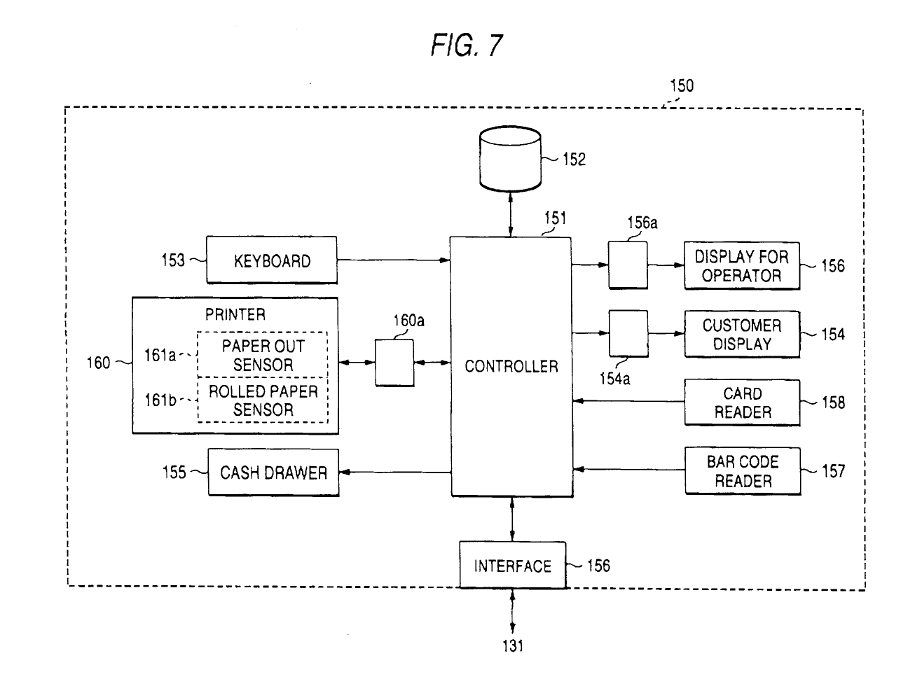

FIG. 7 is a block diagram showing the structure of the internal circuit of the POS terminal device 150. The POS terminal device 150 includes the controller 151 having a CPU, a storage device 152 such as an HDD, the keyboard 153 for an operator, the customer display 154, the cash drawer 155, the display 156 for an operator, the bar code reader 157, a card reader 158 and the printer 160, and each of these devices is controlled by the controller 151. The display 156 is connected to a dedicated driver circuit 156a and the display 154 is connected to a dedicated driver 154a. The controller 151 communicates with the store server 131 through an interface 159. The controller 151 has a CPU, an ROM, an RAM and a real time clock which are not shown and serves to unify and control the POS terminal device 150. The printer 160 has a dedicated printer control section 160a, and the printer control section and the printer are generally accommodated integrally in a housing. The printer 160 has various sensors, and has a paper out sensor 161a for detecting that the rolled paper for recording runs out or nearly runs out and a rolled paper sensor 161b for detecting whether the rolled paper is set or not as a typical example. In addition, there is provided a cover open sensor for detecting the opening or closing operation of a cover in the housing for accommodating the rolled paper, which is not shown.

An ink jet printer comprises an ink out sensor for detecting whether an ink runs out or not, a cartridge sensor for detecting the attachment of an ink cartridge, and a cover open sensor for detecting the opening and closing operation of a cover. By such a structure, generally, both the thermal printer and the ink jet printer have such a structure that an alarm can be given to an operator before a recording medium runs out, and can avoid printing troubles during printing.

While a printer dedicated to a receipt is generally used for the printer 160, any printer capable of carrying out printing on each of a surface and a back face of a receipt paper can print advertisement information on the back face. Moreover, a color printer capable of carrying out multicolored printing can also print the advertisement information in colors, thereby enhancing the effect of the advertisement still more.

While the description has been given by taking, as an example, the POS terminal device in the convenience store to be the POS terminal device 150 in FIGS. 5, 6 and 7, any device for issuing the receipt 170, for example, a clearing register in a hospital and a clearing register in a pharmacy can be used as the POS terminal device in the same manner.

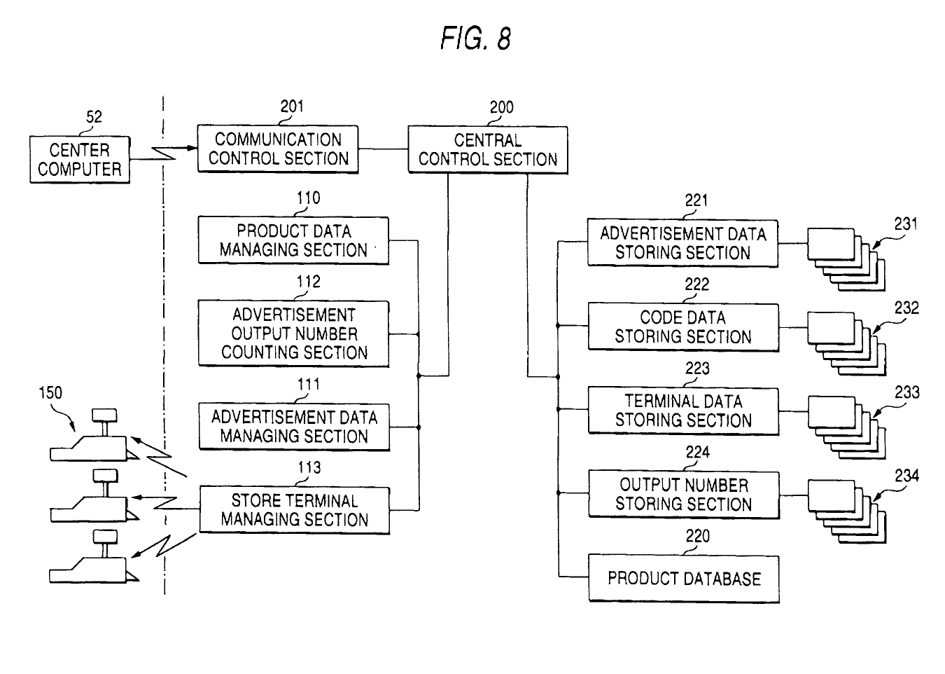

With reference to FIG. 8, next, description will be given to the internal structure of the store POS system receiving information delivery. FIG. 8 is a diagram showing the functional structure of the store server 131 according to the invention.

A plurality of POS terminal devices 150 are connected to the store server 131. The store server 131 has a central control section 200 and serves to control the whole store terminal devices 150 and to transfer data to/from the acceptance and delivery server system 51 through a communication control section 201 and the center computer 52. The central control section 200 comprises a product data managing section 110, an advertisement data managing section 111, an advertisement output number counting section 112 and a POS terminal device managing section 113.

Furthermore, an advertisement data storing section 221, a code data storing section 222, a terminal data storing section 223, an output number storing section 224 and a product database 220 are constructed by using a storage device such as a hard disk drive.

231, 232, 233 and 234 denote respective storage areas, and advertisement information is related to an advertisement code thereof and is thus retained for each application unit.

The advertisement data managing section 111 serves to receive the advertisement information and to store the same advertisement information in the advertisement data storing section 221 or to erase unnecessary data. Moreover, the POS terminal device 150 exchanges a rolled paper. When a bar code added to a new rolled paper is read, the store terminal managing section 113 of the store server 131 is notified of the bar code. The store terminal managing section 113 retrieves advertisement data corresponding to the bar code, transmits the advertisement data corresponding to the bar code to the POS terminal device 150, and at the same time, sends a notice to the advertisement data managing section 111. In the respective terminal devices, timings in which the rolled paper runs out are usually different from each other, and furthermore, the bar code added to the rolled paper is not always identical. Under such conditions, the advertisement data managing section 111 executes a processing of invalidating a print output such as the erasure of unnecessary data, and reliably sets, to the POS terminal device, the advertisement information corresponding to the bar code added to the rolled paper attached to each POS terminal.

The advertisement output number counting portion 112 counts the print output number of each advertisement information printed and output at each terminal and stores the result in an output number storing section. The product data managing section 110 maintains and manages a product database.

Procedure for Advertisement Application

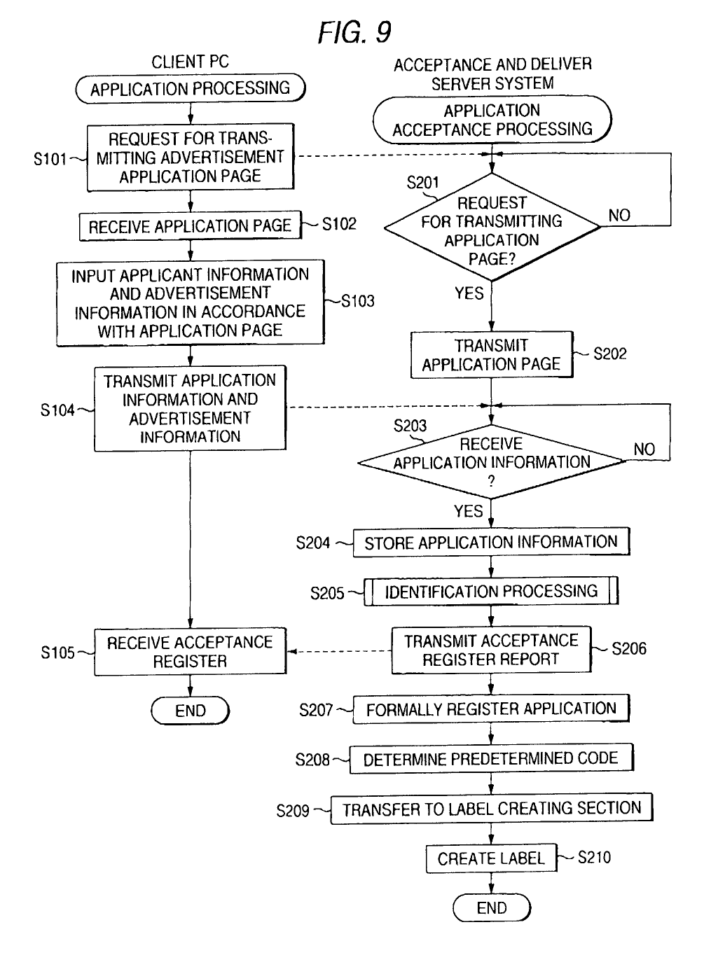

With reference to FIG. 9, description will be given to a procedure for making an application for an advertisement insertion from the client PC 55. FIG. 9 is a flow chart for explaining a processing of making an application for an advertisement insertion in the client PC 55 and the acceptance and delivery server system 51.

When the client PC 55 acquires the home page of the acceptance and delivery server system 51 and makes an application for an advertisement insertion from the home page, the browser of the client PC 55 gives a request for the transmission of an advertisement application page to the acceptance and delivery server system 51 (S101). Upon receipt of the request for the transmission of the advertisement application page (S201: Yes), the WWW server 111 of the acceptance and delivery server system 51 transmits the application page 113 to the client PC 55 (S202). For simplicity of the description, the application page 113 is stored in the WWW server 111 and the application page is transmitted to the client PC 55 through only the WWW server 111. However, data input to the client PC 55 are to be actually received by the acceptance and delivery server system 51.

When the client PC 55 receives the application page 113 transmitted from the acceptance and delivery server system 51 (S102), the advertiser 10 to be an application customer carries out a predetermined input in accordance with the form of the application page 113 which is displayed on the PC (S103). The application page 113 requires information about an applicant, for example, an address, the name of a company or a name, a telephone number and an E-mail address, and furthermore, information such as an application history, and the advertiser inputs the information correspondingly. The E-mail address is utilized for various contacts sent from an advertisement insertion service provider. Typical examples include a contact to confirm an application and sending of a bill and a receipt of a charge.

The application page is provided with an input column for an input text to be advertisement information, and is constituted such that the text can be input and an image file can be attached in the case of an image. Furthermore, the application page may be constituted to specify a print size thereof. When an operation for inputting all necessary information is ended, the input data are transmitted as application information and advertisement information to the acceptance and delivery server system 51 (S104). When

When the acceptance and delivery server system 51 receives application information and advertisement information (hereinafter referred to as application information) which are transmitted from the client PC 55 (S203: Yes), the application information is stored in the customer management information storing section 123, the advertisement information storing section 124 and the advertisement information management information storing section 125 according to each information (S204). At this time, an acceptance management number is added for each application unit, and is stored for each application unit in a predetermined area of the advertisement management information storing section 125 together with received information related thereto. Since an identification procedure has not been completed in this stage, temporary storage is simply carried out.

Next, an identification processing is executed based on a credit number or information such as past use results (S205). At the same time, a charge for using is calculated based on the number of rolled papers for an advertisement insertion, and the issuance of a bill is also prepared through an E-mail. When the identification is ended, a report that an acceptance has been registered is transmitted to an applicant (S206) (which is not shown). Then, a formal acceptance register is executed (S207) and a predetermined code is decided based on application information and advertisement information (S208).

The predetermined code is transferred to the label creating section 130 (S209), and the predetermined code is converted into bar code data and labels corresponding to the number of rolled papers specified by the application page are created in the label creating section (S210). In the case in which the labels are to be stuck onto a rolled paper body and a wrapping paper thereof, the number of the labels is at least a double of the number of applications.

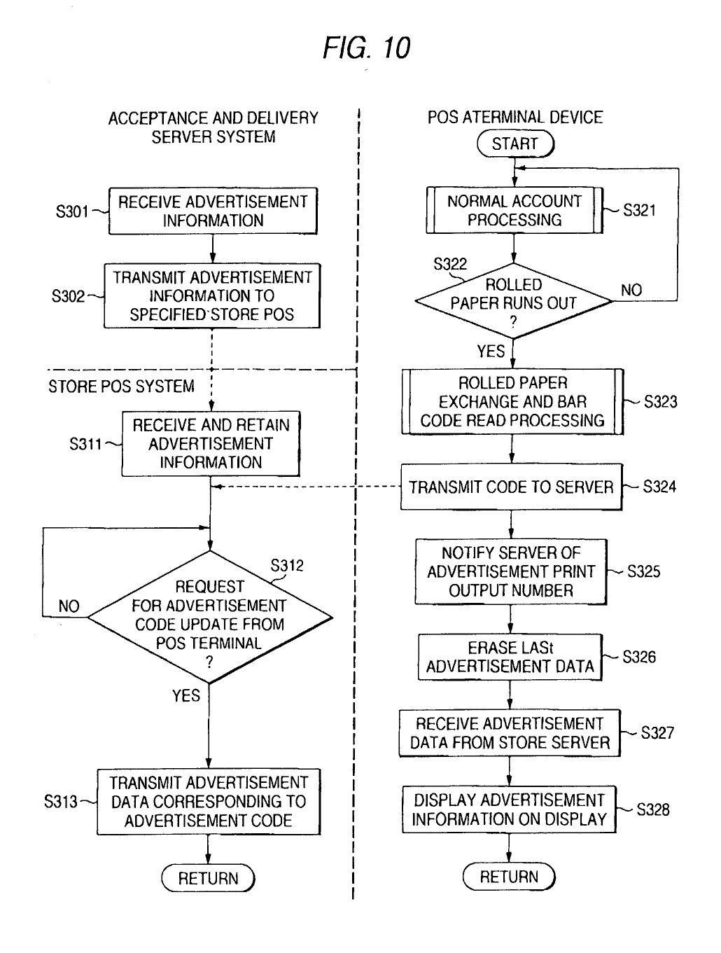

FIG. 10 is a flow chart for a processing of setting and printing advertisement information in the store POS system 53, which will be described below.

The acceptance and delivery server system receives the advertisement information (S301) and delivers the same advertisement information to the store POS system of a chain store which is specified by an advertiser (3302). The store POS system receives the transmitted advertisement information and retains the same advertisement information in the storage device (S311). When a rolled paper is exchanged, a new advertisement code is read and a request for updating the advertisement code is transmitted from the POS terminal device (S312), and advertisement data corresponding thereto are transmitted to the POS terminal device (S313).

In the POS terminal device, a normal money register processing including the print of the advertisement information is executed (S321). When a state indicating that the rolled paper runs out is detected by a paper out sensor (S322), a processing of exchanging the rolled paper and reading a bar code added to the rolled paper is executed (S323) and a bar code of a new rolled paper is transmitted to the server (S324). Moreover, the server is notified of an output number based on the print and output on the rolled paper which is taken out (S325). The data are used for a service to be given to the advertiser. Consequently, data related to the last rolled paper are not required and are thus erased from the terminal device (S326). Next, advertisement data corresponding to the bar code of the new rolled paper are received from the store server (S327) and are stored in the storage device to provide for the print and output. Moreover, in the case in which print information and additional information such as the message of the advertiser include data to be displayed on a display if necessary, the same data are displayed on the customer display (S328).

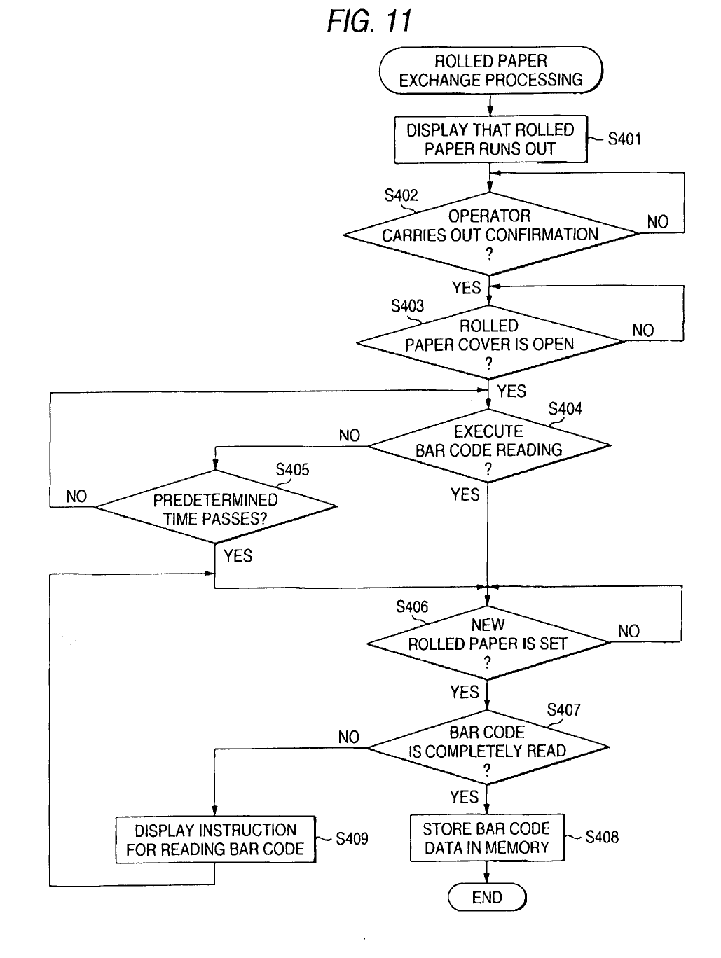

FIG. 11 is a flow chart showing, in more detail, the processing of exchanging a rolled paper and reading a bar code in FIG. 10.

When detecting that the rolled paper runs out (paper out) or nearly runs out by using the paper out sensor, the POS terminal device displays the effect on the display for an operator (S401) When confirming the effect, the operator executes a predetermined key operation. Thus, it is checked whether or not the operator is aware of the paper out situation (S402). Next, whether a cover in a portion accommodating the rolled paper is opened is checked by using a cover open sensor (S403). Then, whether the bar code of the rolled paper is read is checked (S404). If the bar code is not read (No: S404), whether a predetermined time has passed is checked (S405). If the predetermined time has passed (Yes: S405), the processing proceeds to a next step in disregard. If the predetermined time has not passed, the presence of the execution of the bar code reading is checked again (S404).

Irrespective of the execution of bar code reading, whether a new rolled paper is set is subsequently checked by using a rolled paper sensor (S406). The routine stands by until the new rolled paper is set. When the rolled paper is completely set (Yes: S406), whether the bar code is completely read is checked (S407) If the bar code is not completely read, an instruction for reading the bar code is displayed on the display for an operator (S409). The routine repetitively stands by until the bar code is read. When the bar code is read, the bar code data are stored in the predetermined area of the storage device (S408) and the processing of exchanging the rolled paper is ended.

In some cases, a rolled paper which is not specified by advertisement information might be used. In these cases, a private bar code indicative of “no advertisement print” which is prepared by a store may be read or the effect may be input through a keyboard.

In the case in which the state of the bar code is poor and the reading operation cannot be carried out, moreover, it is preferable that the input from the keyboard should be accepted.

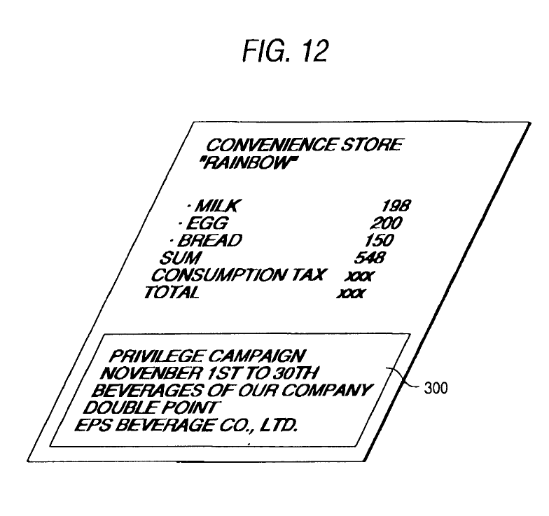

FIG. 12 is a view showing an example of a receipt on which advertisement information is printed under account processing data. There is illustrated a state in which advertisement information 300 is printed on the receipt. By a series of processes described above, the advertisement information 300 prepared by an advertiser can be printed timely on the receipt by using a print medium specified by the advertiser.

The description has been given by using the example in which the receipt printer is the thermal printer and the print medium is the thermal recording paper. In the case in which the receipt printer is an ink jet printer and the print medium is an ink, a label having a bar code printed thereon is stuck to a container for accommodating the ink so that an identical processing can be carried out. Such an embodiment is also one of the embodiments according to the invention.

Moreover, while the bar code is used as a medium for adding a predetermined code in the embodiment, the invention is not restricted thereto but, for example, an OCR character may be used In addition, data may be set into a flash memory which has been used in an ink jet cartridge in recent years.

In the embodiment, furthermore, advertisement data are updated when a rolled paper is exchanged. For the same advertiser, the advertisement data retained in the POS terminal are updated at the request of the advertiser. Consequently, it is possible to carry out a change into the newest advertisement data without waiting for the exchange of the rolled paper. In consideration of this respect, it is preferable that a code corresponding to advertisement information should be constituted by a code indicative of an advertiser and a serial number indicative of the specific advertisement of the advertiser, for example. Furthermore, if the serial number is a predetermined number, for example, 0000, it is also possible to always update the data into the newest data without designating the specific advertisement information of the advertiser.

As described above, according to the system or method in accordance with the invention, a company or a person which desires advertisement delivery can make an application for an advertisement insertion on a receipt or a ticket issued by a convenience store or a supermarket which is connected to the system by using a PC capable of accessing the internet through a network.

According to the invention, moreover, the advertisement information is delivered to respective stores through the network Therefore, the advertisement information can be updated very rapidly and easily. As such, in the case in which the term of advertisement information having a term limitation passes, the contents of the advertisement can be changed quickly. In a preprinted paper according to the related art, there is generated a situation in which the paper having a term expired is to be discarded. However, such a situation can be prevented, which is very efficient.

Furthermore, it is possible to construct a mechanism for causing an advertiser to meet the cost of a print medium. In a store, therefore, the cost of a rolled paper can be reduced. Consequently, the advertiser can carry out efficient advertising so that a cost savings advantage can be obtained.

Furthermore, an advertisement is delivered by practically using the network so that information is transferred in a two-way direction. Consequently, it is possible to provide such a service as to inform an advertiser of the situation of the advertisement.

According to the invention, moreover, it is possible to efficiently deliver advertisement information by utilizing various store networks such as a convenience store and a chain store which have already been set up. Thus, it is also possible to easily update the advertisement information timely.

What is claimed is:

1. A POS system comprising:
a POS terminal device having a printing device for printing POS information and a display device, the POS system further comprising:
a storage device for storing predetermined codes and associated advertisement information;
a print medium or a container thereof which is used in the printing device and has at least one of the codes added to at least one of a body and a wrapper of the print medium or container;
a code reader for reading the code added to the print medium or the container thereof; and
a print controller for controlling printing of the advertisement information together with the POS information, wherein the advertisement information associated with the code is printed together with the POS information while the print medium or the container thereof is attached to the printing device

2. A network system comprising a server system and a POS system including a POS terminal having a printing device for printing POS information and a display device, the network system further comprising:
(a) an advertisement data delivery network for delivering advertisement data including predetermined codes and associated advertisement information from the server system to the POS system;
(b) a print medium or a container thereof which is used in the printing device and has one of the predetermined codes added to at least one of a body and a wrapper of the print medium or container;
(c) a code reader for reading the code added to the print medium or the container thereof;
(d) a data storage and management device for retaining and manipulating the delivered advertisement data in the POS system, and for comparing the code read by the code reader with the predetermined codes, thereby determining associated advertisement information; and
(f) a print controller for controlling printing of the determined advertisement information together with the POS information.

3. The network system according to claim 2, further comprising a center computer for unifying and controlling a plurality of store POS systems provided corresponding to each chain store having a plurality of branches or subscriber stores.

4. The POS system according to claim 1, wherein the POS terminal device includes a print medium detector for detecting attachment and removal of the print medium or the container thereof, the print controller operable to stop the printing of the advertisement information when the print medium detector detects that the print medium or the container thereof is removed from the POS system.

5. The POS system according to claim 4, wherein the POS terminal device includes a display controller for controlling the display of an instruction for reading the code of the print medium or the container thereof on the display device when the print medium detector detects that the print medium or the container thereof is removed or attached.

6. The POS system according to claim 4, wherein the POS terminal device includes a code controller for transferring the code to an upper device when an operation for reading the code of the print medium or the container thereof is executed after attachment of the print medium or the container thereof is detected.

7. The POS system according to claim 1, wherein the printing device to be used in the POS terminal device is an ink jet printer and the print medium or the container thereof is an ink cartridge for accommodating an ink of the ink jet printer therein.

8. The POS system according to claim 1, wherein the code added to the print medium or the container thereof is a bar code.

9. The POS system according to claim 1, wherein the code added to the print medium or the container thereof is a code for determining an advertiser and advertisement information.

10. The POS system according to claim 1, wherein the printing device to be used in the POS terminal device is a thermal printer, and the print medium or the container thereof is a thermal recording paper of the thermal printer.

11. The POS system according to claim 1, further comprising at least one POS terminal device having a printer capable of printing and issuing a receipt, the advertisement information being printed on a surface or a back face of the receipt.

12. The POS system according to claim 10, wherein the code is a bar code which is added to at least one of a tip portion of a rolled paper of the thermal recording paper and a wrapping paper for wrapping the rolled paper.

13. An advertisement information delivering method in a network system comprising at least a server system and a POS system including a store POS terminal device having a display device and a print device, comprising the steps of:
(a) delivering advertisement information to be printed on a receipt in a store POS terminal device corresponding to a predetermined code from the server system to the POS system through a network;
(b) reading a code added to a print medium attached to the printing device or a container accommodating the print medium in the store POS terminal device of the POS system;
(c) determining the advertisement information based on the code added to the print medium or the container accommodating the print medium which is read; and
(d) printing the advertisement information corresponding to the code added to the print medium or the container accommodating the print medium which is specified, on the receipt of the store POS terminal device together with receipt information of the POS terminal device.

14. The advertisement information delivering method according to claim 13, further comprising the steps of:
(e) detecting attachment and removal of the print medium or the container accommodating the print medium; and
(f) stopping the printing of the advertisement information corresponding to the print medium or the container accommodating the print medium when the removal of the print medium or the container accommodating the print medium is detected.

15. The advertisement information delivering method according to claim 13, further comprising the steps of:
(g) detecting the attachment of the print medium or the container accommodating the print medium; and
(h) reading the code or displaying an instruction for an input on the display device when an operation for reading the code added to the print medium or the container accommodating the print medium is not executed before the attachment of the print medium or the container accommodating the print medium.

16. The advertisement information delivering method according to claim 13, further comprising the step of:
(i) reading the code added to the print medium or the container accommodating the print medium and then transferring the code to an upper device.

17. A computer readable recording medium recording the steps of the advertisement information delivering method according to claim 13.
